(19) United States
(12) Patent Application Publication
(10) Pub. No.: US 2023/0260395 A1
(43) Pub. Date: Aug. 17, 2023

(54) CORRECTION DATA GENERATION DEVICE, CORRECTION DATA GENERATION METHOD AND COMPUTER READABLE MEDIUM

(71) Applicant: Mitsubishi Electric Corporation, Tokyo (JP)

(72) Inventor: Yosuke ISHIWATARI, Tokyo (JP)

(73) Assignee: Mitsubishi Electric Corporation, Tokyo (JP)

(21) Appl. No.: 18/139,009

(22) Filed: Apr. 25, 2023

Related U.S. Application Data
(63) Continuation of application No. PCT/JP2020/047418, filed on Dec. 18, 2020.

(51) Int. Cl. G08G 1/01

(52) U.S. Cl. CPC G08G 1/0141; G08G 1/0125; G08G 1/0112

(57) ABSTRACT

A reception unit (101) receives from each moving body among a plurality of moving bodies, moving body data indicating a measured position of each moving body which is a position of each moving body measured at each moving body and may include an error, and indicating a measured position of a surrounding object of each moving body which is a position of the surrounding object of each moving body measured at each moving body and may include an error. A correction data generation unit (102) generates for each moving body, correction data for correcting the error that may be included in the measured position of each moving body, with using measured positions of the plurality of moving bodies and measured positions of surrounding objects of the plurality of moving bodies indicated in a plurality of moving body data received from the plurality of moving bodies. A transmission unit (103) transmits to each moving body, the correction data for each moving body generated by the correction data generation unit (102).

### CROSS REFERENCE TO RELATED APPLICATIONS

This application is a Continuation of PCT International Application No. PCT/JP2020/047418, filed on Dec. 18, 2020, all of which is hereby expressly incorporated by reference into the present application.

### TECHNICAL FIELD

The present disclosure relates to a technique to correct a measured position of a vehicle.

### BACKGROUND ART

In recent years, research and development have been progressing on an on-vehicle system in which a plurality of sensors is installed and sensor data acquired by the plurality of sensors is used.

Further, research and development have been progressing also on a system that receives through a vehicle-to-vehicle communication, sensor data of a sensor installed in another vehicle and uses the received sensor data.

Furthermore, research and development have been progressing also on a system that builds a coalition of data processing between a vehicle and a roadside server, with using a roadside-to-vehicle communication between the vehicle and the roadside server.

Here, a system is considered in which a moving body such as a vehicle or a person transmits each position to a roadside server and the roadside server recognizes the position of each moving body. In such a system, for example, it is possible for the roadside server to notify a vehicle a in advance of a vehicle b and/or a person whose position is not recognized by the vehicle a.

Further, if the vehicle a transmits to the roadside server, a position of the vehicle a together with a position of a vehicle x acquired by the sensor, it is possible for the roadside server to recognize the position of the vehicle x which is not able to transmit own position to the roadside server.

Positional information to be transmitted to the roadside server, by a moving body such as a vehicle or a person may include an error. For this reason, “positions of the same moving body” measured by a plurality of moving bodies may be “consistent with each other”. Alternatively, “positions of the same moving body” measured by the plurality of moving bodies may “not” be consistent with each other.

That is, a situation may occur where the position of the vehicle a measured by the vehicle a is consistent with the position of the vehicle a measured by the vehicle b, but the position of a vehicle c measured by the vehicle a is not consistent with the position of the vehicle c measured by the vehicle b.

In such a situation, it is necessary to determine whether “consistent positions” are correct or “non-consistent positions” are correct. When “consistent positions” are correct, it is also necessary to determine how to correct “non-consistent positions”.

As a technique to perform correction based on a plurality of measurement results, there is a technique described in Patent Literature 1.

In Patent Literature 1, a vehicle α measures own position and acquires positional information of the vehicle α measured by a surrounding vehicle β. Then, the vehicle α calculates a range of the vehicle α, from an error between the measured position of the vehicle α measured by the vehicle α and the measured position of the vehicle α acquired from the vehicle β. The vehicle α performs the same process on a plurality of surrounding vehicles. Then, the vehicle α corrects the position of the vehicle α so that the position of the vehicle α is in an overlapping range acquired after the same process has been repeated on the plurality of surrounding vehicles.

### CITATION LIST

### Patent Literature

Patent Literature 1: JP 6464978 B2

### SUMMARY OF INVENTION

### Technical Problem

In the technique of Patent Literature 1, the vehicle α is not able to correct the position unless the vehicle α repeats a plurality of times to receive a measured position from a surrounding vehicle and repeats a plurality of times to collate the measured position from the surrounding vehicle with the measured position by the vehicle α.

For this reason, the technique of Patent Literature 1 has a problem in that it takes time to correct the position.

One of the main aims of the present disclosure is to solve such a problem. More specifically, the present disclosure mainly aims to correct a position in a short time.

### Solution to Problem

A correction data generation device according to the present disclosure includes:

a reception unit to receive from each moving body among a plurality of moving bodies, moving body data indicating a measured position of each moving body which is a position of each moving body measured at each moving body and may include an error, and indicating a measured position of a surrounding object of each moving body which is a position of the surrounding object of each moving body measured at each moving body and may include an error;

a correction data generation unit to generate for each moving body, correction data for correcting the error that may be included in the measured position of each moving body, with using measured positions of the plurality of moving bodies and measured positions of surrounding objects of the plurality of moving bodies indicated in a plurality of moving body data received from the plurality of moving bodies; and

a transmission unit to transmit to each moving body, the correction data for each moving body generated by the correction data generation unit.

### Advantageous Effects of Invention

According to the present disclosure, it is possible to correct a position in a short time.

### BRIEF DESCRIPTION OF DRAWINGS

FIG. 1 is a diagram illustrating a configuration example of a position correction system according to a first embodiment.

FIG. 2 is a diagram illustrating an outline of a processing procedure of the position correction system according to the first embodiment.

FIG. 3 is a diagram illustrating a functional configuration example of an on-vehicle device according to the first embodiment.

FIG. 4 is a diagram illustrating a functional configuration example of a correction data generation device according to the first embodiment.

FIG. 5 is a diagram illustrating a hardware configuration example of the on-vehicle device according to the first embodiment.

FIG. 6 is a diagram illustrating a hardware configuration example of the correction data generation device according to the first embodiment.

FIG. 7 is a flowchart illustrating an operation example of the on-vehicle device according to the first embodiment.

FIG. 8 is a flowchart illustrating an operation example of the on-vehicle device according to the first embodiment.

FIG. 9 is a flowchart illustrating an operation example of the correction data generation device according to the first embodiment.

### DESCRIPTION OF EMBODIMENTS

Hereinafter, embodiments will be described with reference to the drawings.

In the following description of the embodiments and the drawings, parts assigned the same reference numerals indicate the same parts or corresponding parts.

### First Embodiment

### Description of Configuration

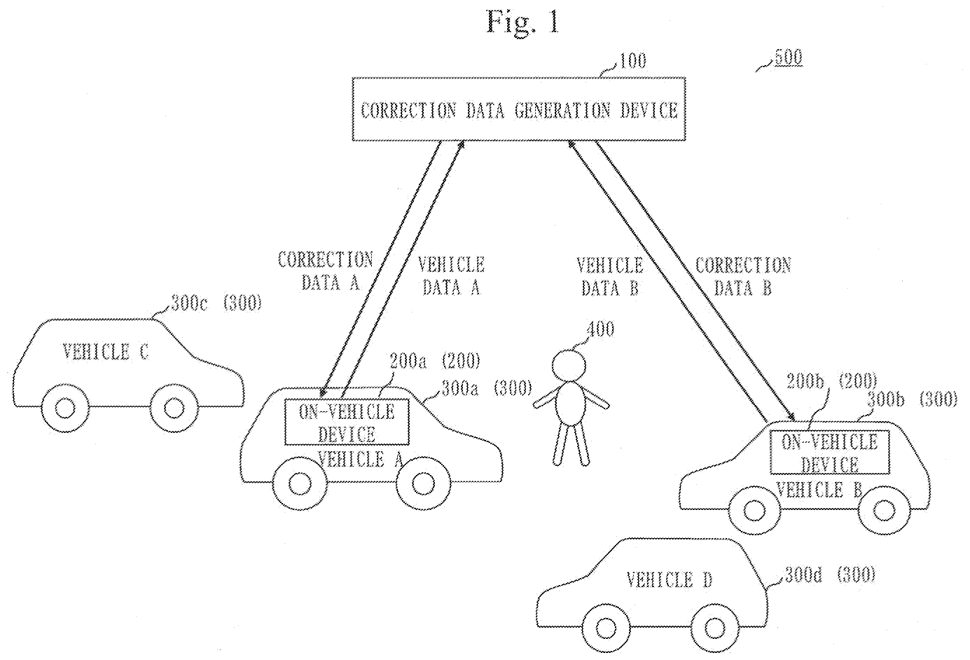

FIG. 1 illustrates a configuration example of a position correction system 500 according to the present embodiment.

The position correction system 500 according to the present embodiment includes a correction data generation device 100, an on-vehicle device A 200a, and an on-vehicle device B 200b.

The on-vehicle device A 200a is mounted on a vehicle A 300a. The on-vehicle device B 200b is mounted on a vehicle B 300b. It is assumed that there is no on-vehicle device mounted on a vehicle C 300c and a vehicle D 300d.

Each of the vehicle A 300a, the vehicle B 300b, the vehicle C 300c, the vehicle D 300d, and a pedestrian 400 is a moving body.

Further, each of the vehicle B 300b, the vehicle C 300c, the vehicle D 300d, and the pedestrian 400 which is a moving body existing in the surrounding of the vehicle A 300a, is equivalent to a surrounding object of the vehicle A 300a. Similarly, each of the vehicle A 300a, the vehicle C 300c, the vehicle D 300d, and the pedestrian 400 which is a moving body existing in the surrounding of the vehicle B 300b is equivalent to a surrounding object of the vehicle B 300b.

In the following, when it is not necessary to distinguish between each of the vehicle A 300a, the vehicle B 300b, the vehicle C 300c, the vehicle D 300d, and a vehicle not illustrated in FIG. 1, they are collectively referred to as a vehicle 300.

Further, when it is not necessary to distinguish between the on-vehicle device A 200a and the on-vehicle device B 200b, they are collectively referred to as an on-vehicle device 200.

The on-vehicle device A 200a measures a position of the vehicle A 300a. Further, the on-vehicle device A 200a measures positions of the surrounding objects of the vehicle A 300a. The on-vehicle device A 200a measures a speed of the vehicle A 300a and speeds of the surrounding objects.

The on-vehicle device A 200a transmits a measurement result to the correction data generation device 100, as vehicle data A. The vehicle data A is equivalent to moving body data. The measurement result of the on-vehicle device A 200a includes the measured position of the vehicle A 300a, the measured positions of the surrounding objects of the vehicle A 300a, the measured speed of the vehicle A 300a, and the measured speeds of the surrounding objects.

The measurement result of the on-vehicle device A 200a may include a measurement error.

In the present embodiment, it is assumed that the on-vehicle device A 200a is able to measure only the positions and speeds of the vehicle B 300b, the vehicle C 300c, and the pedestrian among the surrounding objects.

Similarly, the on-vehicle device B 200b measures a position of the vehicle B 300b. Further, the on-vehicle device B 200b measures positions of the surrounding objects of the vehicle B 300b. The on-vehicle device B 200b measures a speed of the vehicle B 300b and speeds of the surrounding objects. The on-vehicle device B 200b may not measure the speed of the vehicle B 300b. Here, it is assumed that the on-vehicle device B 200b measures the speed of the vehicle B 300b.

The on-vehicle device B 200b transmits a measurement result to the correction data generation device 100, as vehicle data B. The vehicle data B is equivalent to moving body data. The measurement result of the on-vehicle device B 200b includes the measured position of the vehicle B 300b, the measured positions of the surrounding objects of the vehicle B 300b, the measured speed of the vehicle B 300b, and the measured speeds of the surrounding objects.

The measurement result of the on-vehicle device B 200b may include a measurement error.

In the present embodiment, it is assumed that the on-vehicle device B 200b is able to measure only the positions and speeds of the vehicle A 300a and the vehicle D 300d among the surrounding objects.

An operation procedure of the on-vehicle device 200 is equivalent to an error correction method. Further, a program that implements operation of the on-vehicle device 200 is equivalent to an error correction program.

The correction data generation device 100 is, for example, a roadside server device arranged on a side of a roadway on which the vehicle 300 travels. The correction data generation device 100 may be a server device other than the roadside server device.

An operation procedure of the correction data generation device 100 is equivalent to a correction data generation method. Further, a program that implements operation of the correction data generation device 100 is equivalent to a correction data generation program.

The correction data generation device 100 receives the vehicle data A and the vehicle data B.

Then, the correction data generation device 100 generates correction data for each of the vehicle A 300a and the vehicle B 300b, with using the measurement result included in the vehicle data A and the measurement result included in the vehicle data B.

The correction data (referred to as correction data A) for the vehicle A 300a is data for correcting the measurement error included in the measurement result of the on-vehicle device A 200a. That is, the correction data A is data for correcting the measurement error possibly included in the measured position of the vehicle A 300a and the measurement errors possibly included in the measured positions of the surrounding objects of the vehicle A 300a.

The correction data (referred to as correction data B) for the vehicle B 300b is data for correcting the measurement error included in the measurement result of the on-vehicle device B 200b. That is, the correction data B is data for correcting the measurement error possibly included in the measured position of the vehicle B 300b and the measurement errors possibly included in the measured positions of the surrounding objects of the vehicle B 300b.

Then, the correction data generation device 100 transmits the correction data A to the on-vehicle device A 200a and transmits the correction data B to the on-vehicle device B 200b.

The on-vehicle device A 200a receives the correction data A. Then, the on-vehicle device A 200a corrects a positioning error included in the measured position of the vehicle A 300a, with using the correction data A. In addition, the on-vehicle device A 200a corrects positioning errors included in the measured positions of the surrounding objects of the vehicle A 300a, with using the correction data A.

Similarly, the on-vehicle device B 200b receives the correction data B. Then, the on-vehicle device B 200b corrects a positioning error included in the measured position of the vehicle B 300b, with using the correction data B. In addition, the on-vehicle device B 200b corrects positioning errors included in the measured positions of the surrounding objects of the vehicle B 300b, with using the correction data B.

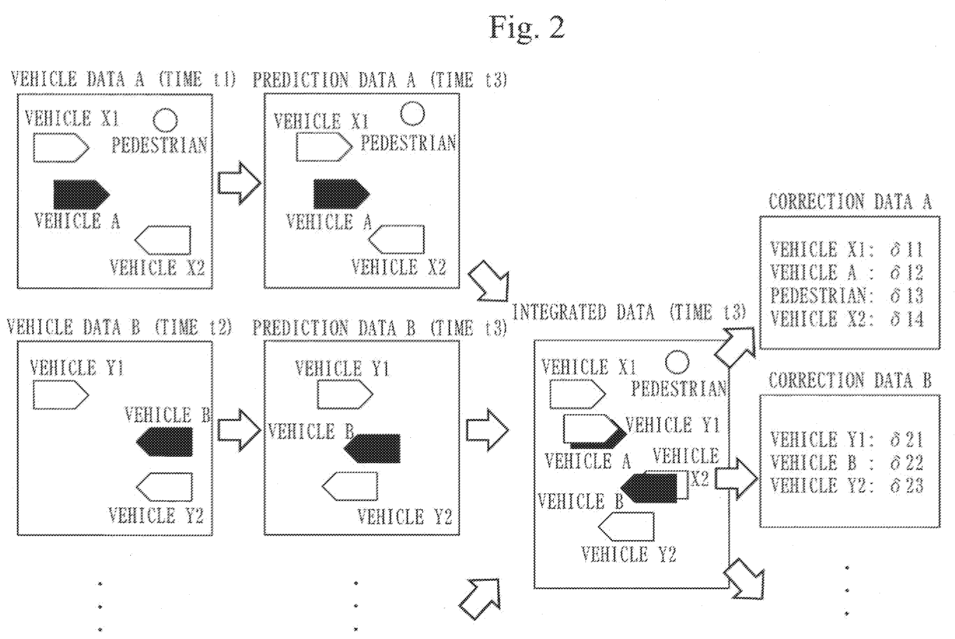

FIG. 2 illustrates an outline of a processing procedure of the position correction system 500 according to the present embodiment.

Before describing detailed configurations of the correction data generation device 100 and the on-vehicle device 200, the outline of the processing procedure of the position correction system 500 will be described.

The correction data generation device 100 receives a plurality of vehicle data from a plurality of vehicles 300. The vehicle data received by the correction data generation device 100 includes the vehicle data A and the vehicle data B.

In the following, one or more pieces of vehicle data other than the vehicle data A and the vehicle data B are collectively referred to as vehicle data N (not illustrated in FIG. 2). Further, a vehicle from which the vehicle data N is transmitted is referred to as a vehicle N 300n (not illustrated).

Further, the vehicle 300 from which the vehicle data is transmitted is also referred to as a transmission source vehicle 300.

As described above, the vehicle data A is data transmitted from the on-vehicle device A 200a of the vehicle A 300a and that indicates the measurement result of the on-vehicle device A 200a. The vehicle data A indicates the measured position of the vehicle A 300a which is the transmission source vehicle 300. Further, the vehicle data A indicates a position of a vehicle X1, a position of a vehicle X2, and a position of a pedestrian, as the measured positions of the surrounding objects. The vehicle X1 is the vehicle C 300c in FIG. 1. The vehicle X2 is the vehicle B 300b in FIG. 1. The pedestrian is the pedestrian 400 in FIG. 1. However, the on-vehicle device A 200a is not able to specify the surrounding objects, so that the on-vehicle device A 200a recognizes the surrounding objects as the vehicle X1, the vehicle X2 and the pedestrian.

It is assumed that the correction data generation device 100 is able to recognize that the vehicle A 300a indicated in the vehicle data A is the transmission source vehicle 300 of the vehicle data A.

As described above, the vehicle data B is data transmitted from the on-vehicle device B 200b of the vehicle B 300b and that indicates the measurement result of the on-vehicle device B 200b. The vehicle data B indicates the measured position of the vehicle B 300b which is the transmission source vehicle 300. Further, the vehicle data B indicates a position of a vehicle Y1 and a position of a vehicle Y2, as the measured positions of the surrounding objects. The vehicle Y1 is the vehicle A 300a in FIG. 1 and the vehicle Y2 is the vehicle D 300d in FIG. 1. However, the on-vehicle device B 200b is not able to specify the surrounding objects, so that the on-vehicle device B 200b recognizes the surrounding objects as the vehicle Y1 and the vehicle Y2.

It is assumed that the correction data generation device 100 is able to recognize that the vehicle B 300b indicated in the vehicle data B is the transmission source vehicle 300 of the vehicle data B.

Although an illustration of the vehicle data N is omitted, it is the same data as the vehicle data A and the vehicle data B described above.

Each of the transmission source vehicles 300 measures the position of the transmission source vehicle 300 and the positions of the surrounding objects at an individual timing. The vehicle data indicates a measurement time at the transmission source vehicle 300.

As illustrated in FIG. 2, the measurement time of the vehicle data A is a time t1. The measurement time of the vehicle data B is a time t2 (t1<t2). Further, the measurement time of the vehicle data N is also an individual time for the transmission source vehicle 300.

In this way, a measurement is not always taken at the same time in each transmission source vehicle 300, so that there may be a difference in the measurement times between pieces of vehicle data.

The correction data generation device 100 removes such a difference in the measurement times. To remove the difference in the measurement times, the correction data generation device 100 sets a time (hereinafter referred to as a reference time) which is a time after the measurement times of a plurality of transmission source vehicles 300 and commonly applied to the plurality of transmission source vehicles 300. Then, the correction data generation device 100 calculates a predicted position of each transmission source vehicle 300 at the reference time and predicted positions of the surrounding objects of each transmission source vehicle 300 at the reference time.

Specifically, the correction data generation device 100 sets as the reference time, a latest measurement time among the measurement times of the plurality of received vehicle data. Then, the correction data generation device 100 predicts the position of each transmission source vehicle 300 at the reference time and the positions of the surrounding objects of each transmission source vehicle 300 at the reference time. When the measurement time is identical with the reference time, the correction data generation device 100 uses the measured position indicated in the vehicle data, as the predicted position.

In an example of FIG. 2, the correction data generation device 100 sets a time t3 (t2<t3) as the reference time and calculates the predicted position of each transmission source vehicle 300 and the predicted positions of the surrounding objects at the time t3.

That is, based on the measured position and the measured speed of the vehicle A 300a indicated in the vehicle data A, the correction data generation device 100 calculates the predicted position of the vehicle A 300a at the time 3. Further, based on the measured position and the measured speed of each surrounding object (the vehicle X1, the vehicle X2, or the pedestrian), the correction data generation device 100 calculates the predicted position of each surrounding object at the time t3. Data that indicates the predicted positions of the vehicle A 300a and each surrounding object at the time t3 is referred to as prediction data A.

Similarly, the correction data generation device 100 calculates also for the vehicle data B, the predicted position of the vehicle B 300b and each surrounding object at the time t3. Data that indicates the predicted positions of the vehicle B 300b and each surrounding object at the time t3 is referred to as prediction data B.

Further, similarly, the correction data generation device 100 calculates also for the vehicle data N, the predicted position of the vehicle N 300n and each surrounding object at the time t3. Data that indicates the predicted positions of the vehicle N 300n and each surrounding object at the time t3 is referred to as prediction data N (not illustrated in FIG. 2).

Next, the correction data generation device 100 generates integrated data by integrating the prediction data A, the prediction data B, and the prediction data N.

In the integrated data of FIG. 2, the predicted position of the vehicle A 300a and the predicted position of the vehicle Y1 partially overlap. Further, the predicted position of the vehicle B 300b and the predicted position of the vehicle X2 partially overlap. The vehicle A 300a and the vehicle Y1 are the same vehicle, so that each predicted position is close to each other, but is not completely consistent with each other due to measurement errors and prediction errors. Similarly, the vehicle B 300b and the vehicle X2 are the same vehicle, so that each predicted position is close to each other, but is not completely consistent with each other due to measurement errors and prediction errors.

The correction data generation device 100 analyzes a distribution of the predicted positions acquired by the integration and calculates a position at which the transmission source vehicle 300 is estimated to be located at the reference time t3, as an estimated position of the transmission source vehicle 300. In the example of FIG. 2, the correction data generation device 100 analyzes the distribution of the predicted position of the vehicle A 300a and the predicted position of the vehicle Y1 and calculates the estimated position of the vehicle A 300a. Similarly, the correction data generation device 100 analyzes the distribution of the predicted position of the vehicle B 300b and the predicted position of the vehicle X2 and calculates the estimated position of the vehicle B 300b.

Further, the correction data generation device 100 calculates positions at which the surrounding objects are estimated to be located at the reference time t3, as estimated positions of the surrounding objects.

Next, the correction data generation device 100 generates the correction data for each of the transmission source vehicles 300, with using the estimated position of the transmission source vehicle 300 and the estimated positions of the surrounding objects. That is, the correction data generation device 100 generates the correction data A which is the correction data for the vehicle A 300a, with using the estimated position of the vehicle A 300a and the estimated positions of the surrounding objects. Further, the correction data generation device 100 generates the correction data B which is the correction data for the vehicle B 300b, with using the estimated position of the vehicle B 300b and the estimated positions of the surrounding objects. Furthermore, the correction data generation device 100 generates correction data N (not illustrated in FIG. 2) which is the correction data for the vehicle N 300n, with using the estimated position of the vehicle N 300n and the estimated positions of the surrounding objects.

For example, the correction data A indicates correction values (δ11 to δ14) for each of the vehicle X1, the vehicle A 300a, the pedestrian, and the vehicle X2 indicated in the vehicle data A. Similarly, the correction data B indicates correction values (δ21 to δ23) for each of the vehicle Y1, the vehicle B 300b, and the vehicle Y2 indicated in the vehicle data B.

The correction values indicated in the correction data eliminate the measurement errors at each on-vehicle device 200. That is, the correction value indicated in the correction data is equivalent to the measurement error at the measurement time of each on-vehicle device 200.

After that, the correction data generation device 100 transmits the correction data A to the vehicle A 300a. Further, the correction data generation device 100 transmits the correction data B to the vehicle B 300b. Furthermore, the correction data generation device 100 transmits the correction data N to the vehicle N 300n.

Next, a functional configuration example and a hardware configuration example of the on-vehicle device 200 according to the present embodiment will be described.

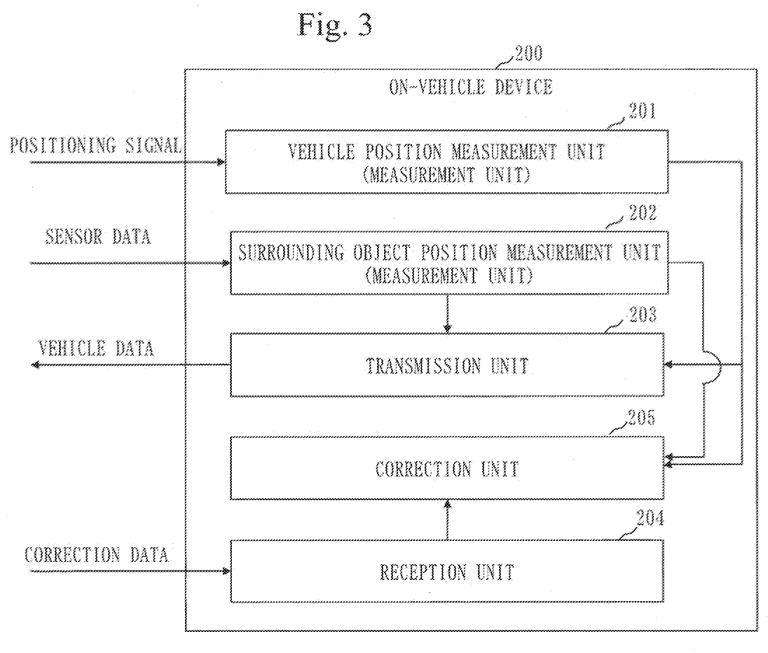

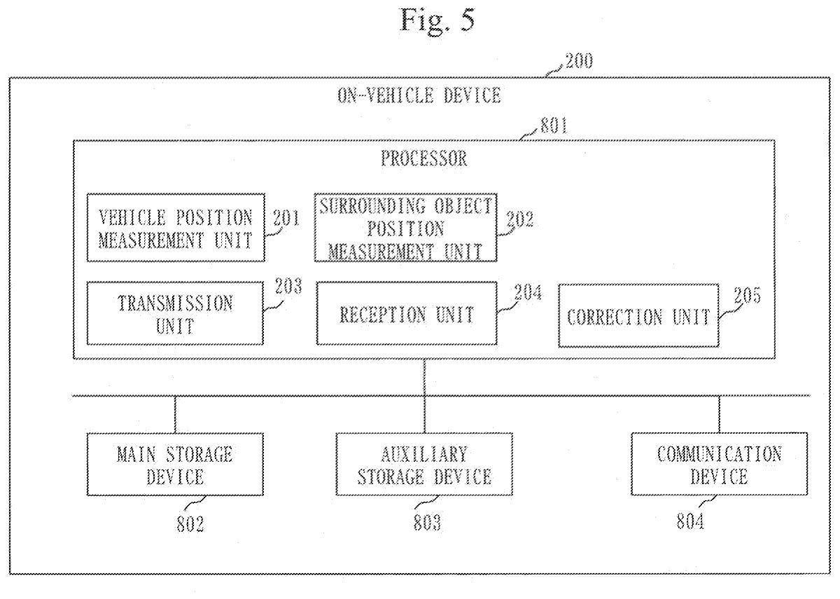

FIG. 3 illustrates the functional configuration example of the on-vehicle device 200 and FIG. 5 illustrates the hardware configuration example of the on-vehicle device 200.

The on-vehicle device 200 is a computer. An operation procedure of the on-vehicle device 200 is equivalent to an error correction method. Further, a program that implements operation of the on-vehicle device 200 is equivalent to an error correction program.

As illustrated in FIG. 5, the on-vehicle device 200 includes a processor 801, a main storage device 802, an auxiliary storage device 803, and a communication device 804, as pieces of hardware.

Further, as illustrated in FIG. 3, the on-vehicle device 200 includes a vehicle position measurement unit 201, a surrounding object position measurement unit 202, a transmission unit 203, a reception unit 204, and a correction unit 205, as functional configurations.

The auxiliary storage device 803 stores programs that implement functions of the vehicle position measurement unit 201, the surrounding object position measurement unit 202, the transmission unit 203, the reception unit 204, and the correction unit 205.

These programs are loaded from the auxiliary storage device 803 into the main storage device 802. Then, the processor 801 executes these programs and performs operation of the vehicle position measurement unit 201, the surrounding object position measurement unit 202, the transmission unit 203, the reception unit 204, and the correction unit 205 to be described below.

FIG. 5 schematically illustrates a state in which the processor 801 executes the programs that implement the functions of the vehicle position measurement unit 201, the surrounding object position measurement unit 202, the transmission unit 203, the reception unit 204, and the correction unit 205.

In FIG. 3, the vehicle position measurement unit 201 measures the position and the speed of the vehicle 300.

The vehicle position measurement unit 201 measures the position of the vehicle 300 with using, for example, a positioning signal from a Global Positioning System (GPS) satellite. Further, the vehicle position measurement unit 201 measures the speed with using, for example, a difference in measured positions in a unit time.

Then, the vehicle position measurement unit 201 outputs to the transmission unit 203, the measurement time, and the measured position and the measured speed of the vehicle 300. The measurement time is a time at which the vehicle position measurement unit 201 has measured the position and the speed of the vehicle 300. The vehicle position measurement unit 201 uses a unified time such as GPS time, as the measurement time. That is, an identical time is used in each vehicle 300. In other words, measurement timings may vary among the vehicles 300, but it is considered that there is no time gap among the vehicles 300.

Further, the vehicle position measurement unit 201 outputs the measured position of the vehicle 300 to the correction unit 205.

The vehicle position measurement unit 201 is equivalent to a measurement unit, together with the surrounding object position measurement unit 202 to be described below. Further, a process to be performed by the vehicle position measurement unit 201 is equivalent to a measurement process, together with a process to be performed by the surrounding object position measurement unit 202.

The surrounding object position measurement unit 202 measures the positions and the speeds of the surrounding objects of the vehicle 300. The surrounding object position measurement unit 202 measures the measured positions and the measured speeds at the same measurement time as that of the vehicle position measurement unit 201.

The surrounding object position measurement unit 202 measures the positions and the speeds of the surrounding objects with using, for example, sensor data from a sensor mounted on the vehicle 30). The surrounding object position measurement unit 202 measures, relative positions and relative speeds from the vehicle 300, as the positions and the speeds of the surrounding objects. In the present embodiment, any method is used by the sensor to detect the surrounding objects. In the present embodiment, an example in which the surrounding object position measurement unit 202 measures the speeds of the surrounding objects will be described, but the surrounding object position measurement unit 202 does not need to measure the speeds of the surrounding objects.

The surrounding object position measurement unit 202 outputs the measured positions and the measured speeds of the surrounding objects to the transmission unit 203. Further, the surrounding object position measurement unit 202 outputs the measured positions of the surrounding objects to the correction unit 205.

The surrounding object position measurement unit 202 is equivalent to the measurement unit, together with the vehicle position measurement unit 201. Further, the process performed by the surrounding object position measurement unit 202 is equivalent to the measurement process, together with the process performed by the vehicle position measurement unit 201.

The transmission unit 203 transmits to the correction data generation device 100, the measurement time, the measured position and the measured speed of the vehicle 300, as well as the measured positions and the measured speeds of the surrounding objects, as the vehicle data. The transmission unit 203 assigns an identifier of the on-vehicle device 200 to the vehicle data and transmits the vehicle data to the correction data generation device 100. It is conceivable to use a unique number (for example, a Media Access Control (MAC) address) of the communication device 804, as the identifier.

A process performed by the transmission unit 203 is equivalent to a transmission process.

The reception unit 204 receives the correction data from the correction data generation device 100.

Then, the reception unit 204 outputs the received correction data to the correction unit 205.

A process performed by the reception unit 204 is equivalent to a reception process.

The correction unit 205 corrects the measured position of the vehicle 300 acquired from the vehicle position measurement unit 201 and the measured positions of the surrounding objects acquired from the surrounding object position measurement unit 202, with using the correction values indicated in the correction data.

Next, a functional configuration example and a hardware configuration example of the correction data generation device 100 according to the present embodiment will be described.

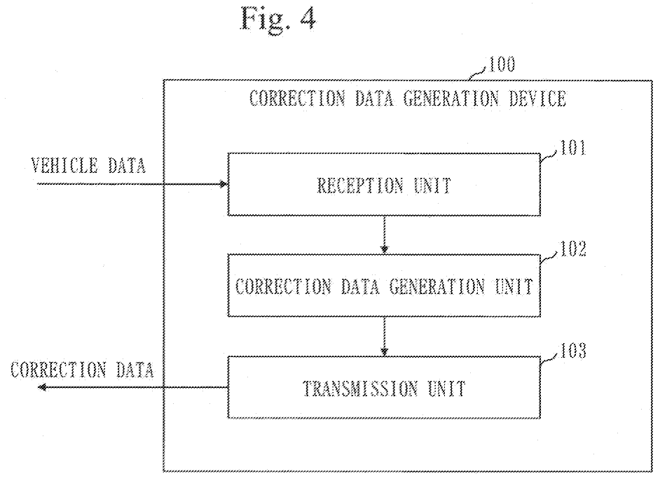

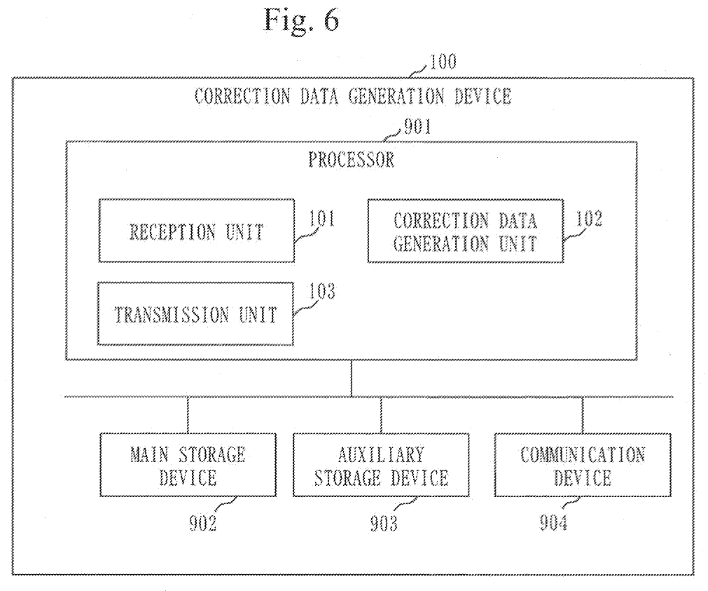

FIG. 4 illustrates the functional configuration example of the correction data generation device 100 and FIG. 6 illustrates the hardware configuration example of the correction data generation device 100.

The correction data generation device 100 is a computer. An operation procedure of the correction data generation device 100 is equivalent to a correction data generation method. Further, a program that implements operation of the correction data generation device 100 is equivalent to a correction data generation program.

As illustrated in FIG. 6, the correction data generation device 100 includes a processor 901, a main storage device 902, an auxiliary storage device 903, and a communication device 904, as pieces of hardware.

Further, as illustrated in FIG. 4, the correction data generation device 100 includes a reception unit 101, a correction data generation unit 102, and a transmission unit 103, as functional configurations.

The auxiliary storage device 903 stores programs that implement functions of the reception unit 101, the correction data generation unit 102, and the transmission unit 103.

These programs are loaded from the auxiliary storage device 903 into the main storage device 902. Then, the processor 901 executes these programs and performs operation of the reception unit 101, the correction data generation unit 102, and the transmission unit 103 to be described below.

FIG. 6 schematically illustrates a state in which the processor 901 executes the programs that implement the functions of the reception unit 101, the correction data generation unit 102, and the transmission unit 103.

In FIG. 4, the reception unit 101 receives the vehicle data transmitted from each on-vehicle device 200.

The reception unit 101 outputs the received vehicle data to the correction data generation unit 102.

A process performed by the reception unit 101 is equivalent to a reception process.

The correction data generation unit 102 acquires the vehicle data from the reception unit 101. Then, the correction data generation unit 102 generates the correction data for each transmission source vehicle 300, with using the plurality of vehicle data from the plurality of on-vehicle devices 200. The correction data generation unit 102 outputs the generated correction data to the transmission unit 103.

A process performed by the correction data generation unit 102 is equivalent to a correction data generation process.

The transmission unit 103 acquires from the correction data generation unit 102, the correction data for each of the transmission source vehicles 300. Then, the transmission unit 103 transmits the corresponding correction data to the on-vehicle device 200 of the transmission source vehicle 300.

A process performed by the transmission unit 103 is equivalent to a transmission process.

### Description of Operation

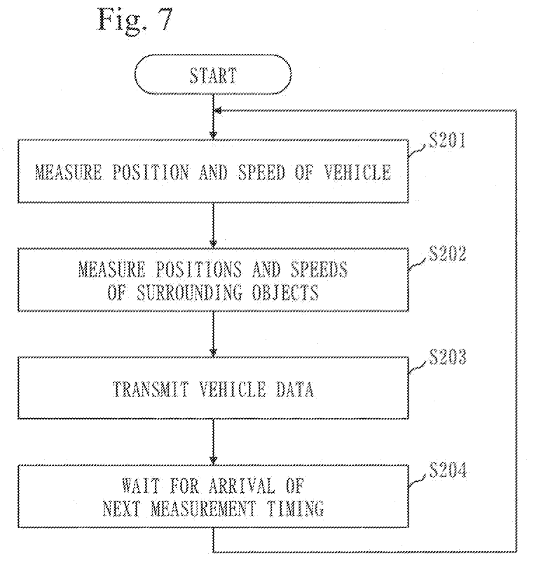

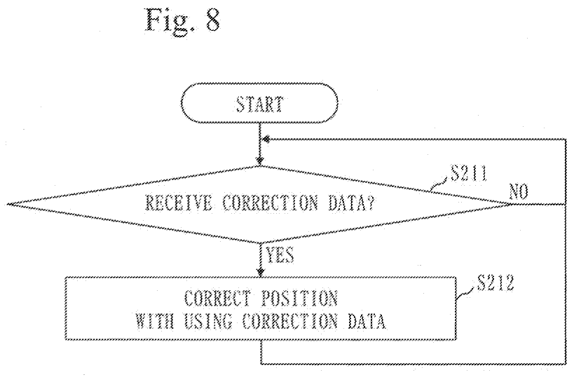

Next, an operation example of the on-vehicle device 200 will be described with reference to FIGS. 7 and 8.

First, FIG. 7 will be described. FIG. 7 illustrates the measurement process of the position and the speed as well as the transmission process of the vehicle data.

When the measurement timing for the position and the speed arrives, the vehicle position measurement unit 201 measures the position and the speed of the vehicle 300 (step S201).

As described above, the vehicle position measurement unit 201 measures the position of the vehicle 300 with using a positioning signal from a GPS satellite. Further, the vehicle position measurement unit 201 measures the speed with using, for example, a difference in measured positions in a unit time.

The vehicle position measurement unit 201 may measure the position and the speed of the vehicle 300, with using the correction value acquired by the correction unit 205 for the measured position of the vehicle 300 at a previous measurement timing.

The surrounding object position measurement unit 202 measures the positions and the speeds of the surrounding objects with using for example, sensor data from a sensor mounted on the vehicle 300 (step S202). The surrounding object position measurement unit 202 measures the relative positions and the relative speeds of the vehicle 300, as the positions and the speeds of the surrounding objects.

The surrounding object position measurement unit 202 may measure the positions and the speeds of the surrounding objects, with using the correction values acquired by the correction unit 205 for the measured positions of the surrounding objects at a previous measurement timing.

In FIG. 7, it is described that step S202 is operated after step S201, but step S201 and step S202 are simultaneously operated.

Next, the transmission unit 203 transmits the vehicle data to the correction data generation device 100 (step S203).

As described above, the transmission unit 203 transmits to the correction data generation device 100, the measurement time, the measured position and the measured speed of the vehicle 300, as well as the measured positions and the measured speeds of the surrounding objects, as the vehicle data. Further, the transmission unit 203 assigns the identifier of the on-vehicle device 200 to the vehicle data and transmits the vehicle data to the correction data generation device 100.

In the present embodiment, it is assumed that the transmission unit 203 has already acquired a communication address of the correction data generation device 100. Any method is used by the transmission unit 203 to acquire the communication address of the correction data generation device 100.

After transmitting the vehicle data, the on-vehicle device 200 waits for the arrival of a next measurement timing (step S204) and starts the processes from step S201 onwards at a time when the next measurement timing arrives.

Next, FIG. 8 will be described. FIG. 8 illustrates the reception process of the correction data and the correction process.

When the reception unit 204 receives the correction data from the correction data generation device 100 (YES in step S211), the correction unit 205 corrects the position of the vehicle 300 and the positions of the surrounding objects with using the correction data (step S212).

As illustrated in FIG. 2, the correction data includes the correction values for correcting the position of the vehicle 300 and the position of each surrounding object. For example, the correction unit 205 acquires the corrected position of the vehicle 300 and the corrected position of each surrounding object, by subtracting the corresponding correction value from the measured position of the vehicle 300 and the measured position of each surrounding object.

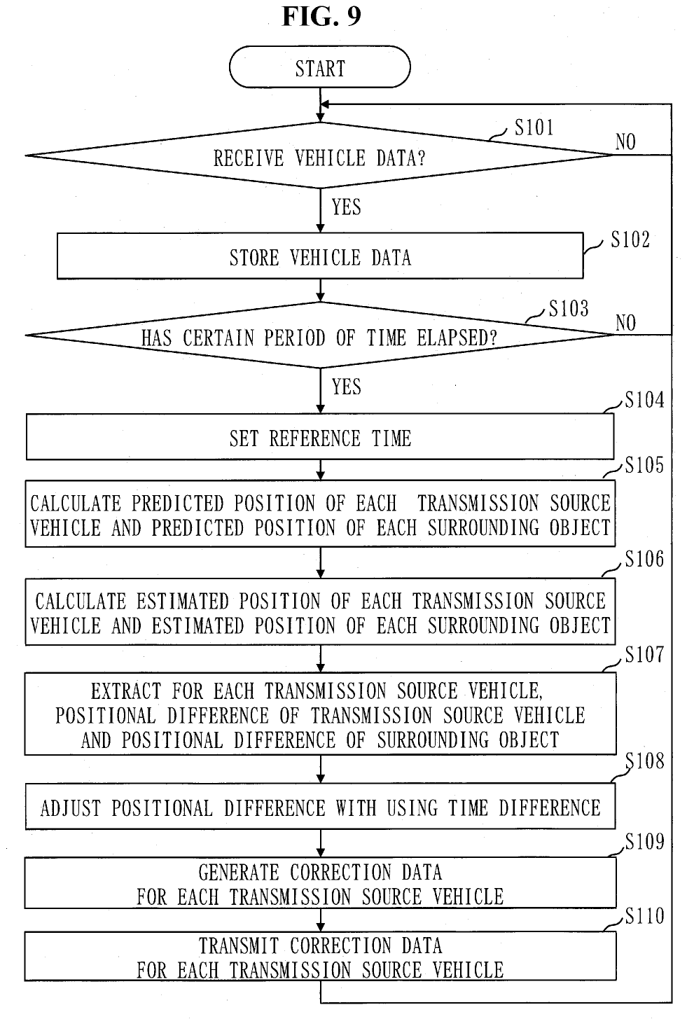

Next, with reference to FIG. 9, an operation example of the correction data generation device 100 will be described.

When the reception unit 101 receives the vehicle data from the vehicle 300 (YES in step S101), the reception unit 101 stores the received vehicle data into the auxiliary storage device 903 (step S102).

Then, the reception unit 101 waits to receive the vehicle data until a certain period of time elapses from a reception time of the first received vehicle data.

After the certain period of time has elapsed from the reception time of the first received vehicle data (YES in step S103), the correction data generation unit 102 sets the reference time (step S104).

Specifically, the correction data generation unit 102 sets a latest measurement time among the measurement times of the vehicle data stored in the auxiliary storage device 903, as the reference time.

Next, the correction data generation unit 102 calculates the predicted position of the transmission source vehicle 300 at the reference time and the predicted positions of the surrounding objects at the reference time (step S105).

The correction data generation unit 102 calculates the predicted position of the transmission source vehicle 300 at the reference time and predicted positions of the surrounding objects at the reference time, with using the measured position and the measured speed of the transmission source vehicle 300 as well as the measured positions and the measured speeds of the surrounding objects.

The correction data generation unit 102 performs a pre-prediction process by means of a Kalman filter and calculates the predicted position of the transmission source vehicle 300 at the reference time and the predicted positions of the surrounding objects at the reference time.

Here, an example will be described in which the correction data generation unit 102 calculates the predicted position of the vehicle A 300a at the reference time t3. It is assumed that the measurement time of the vehicle data received from the vehicle A 300a is the time t1. It is assumed that the auxiliary storage device 903 stores the measured positions and the predicted positions of the vehicle A 300a at past measurement times (time to, time (t−1), and the like).

The correction data generation unit 102 calculates an error between a past measured position and the predicted position calculated to correspond to that measured position. For example, the correction data generation unit 102 calculates an error between the measured position of the vehicle A 300a at the measurement time t0 and the predicted position calculated to correspond to that measured position. Further, the correction data generation unit 102 calculates an error between the measured position of the vehicle A 300a at the time t(−1) and the predicted position calculated to correspond to that measured position. Then, the correction data generation unit 102 calculates by means of the Kalman filter, the predicted position of the vehicle A 300a at the time t2 and the predicted position of the vehicle A 300a at the time t3, with using the calculated errors as well as the measured position and the measured speed of the vehicle A 300a at the measurement time t1.

In the same way, the correction data generation unit 102 calculates the predicted positions of the surrounding objects of the vehicle A 300a at the reference time 3.

The details of the Kalman filter are described in the following reference.

### REFERENCE

Shuichi ADACHI and Ichiro MARUTA, “Fundamentals of Kalman Filter”. Tokyo Denki University Press, 2012.

When the speeds of the surrounding objects are not measured by the vehicle 300, the correction data generation unit 102 determines the predicted position of each surrounding object at the reference time, from the predicted position of the transmission source vehicle 300 (for example, the vehicle A 300a) at the reference time and the relative position of each surrounding object from the transmission source vehicle 300 (for example, the vehicle A 300a) at the measurement time (for example, the time t1).

Next, the correction data generation unit 102 calculates the estimated position of the transmission source vehicle 300 at the reference time (step S106).

Specifically, the correction data generation unit 102 integrates a plurality of prediction data. Then, the correction data generation unit 102 analyzes the distribution of the predicted positions acquired by the integration and calculates a position (an estimated position) at which the transmission source vehicle 300 is estimated to be located at the reference time.

There is a case where the transmission source vehicle 300 is detected as a surrounding object of another vehicle. In the example of FIG. 2, the vehicle A 300a is detected as the surrounding object (the vehicle Y1) of the vehicle B 300b and the vehicle B 300b is detected as the surrounding object (the vehicle X2) of the vehicle A 300a.

Further, due to the measurement errors and the prediction errors, even a plurality of predicted positions of the same transmission source vehicle 30) may not be consistent with each other. That is, in the example of FIG. 2, since the vehicle A 300a and the vehicle Y1 are the same vehicle, two predicted positions are supposed to be consistent with each other. However, due to the measurement errors and the prediction errors, the predicted position of the vehicle A 300a and the predicted position of the vehicle Y1 may not be consistent with each other.

Further, the transmission source vehicle 300 and a surrounding object of another vehicle 300 are not related with each other in ID information or the like. For this reason, the correction data generation unit 102 needs to calculate from the distribution of the predicted positions, the estimated position of the transmission source vehicle 300.

A calculation procedure of the predicted position of the transmission source vehicle 300 will be described below.

In the following, each predicted position acquired by integrating pieces of prediction data is referred to as Pi. The predicted position Pi includes both of the predicted position of the transmission source vehicle 300 and the predicted positions of the surrounding objects. Further, among the predicted positions Pi, the predicted position of the transmission source vehicle 300 is referred to as Po_i.

First, the correction data generation unit 102 groups the predicted positions mutually located within a first distance σ₁ in the distribution of the predicted positions Pi. The predicted positions included in each group acquired by grouping are referred to as GPi.

The size of the first distance σ₁ varies depending on the moving bodies. In the present embodiment, in order to find the estimated position of the vehicle 300, the first distance σ₁ is set to about 2m in consideration of the length and width of the vehicle. When finding the estimated position of another type of moving body, the first distance σ₁ is determined in consideration of the size of the target moving body.

Unless each of the predicted positions GPi is of the same vehicle, a plurality of predicted positions GPi is considered not to come close within the first distance σ₁. In other words, the plurality of predicted positions GPi within the first distance σ₁ is considered to be the predicted positions of the same vehicle. In the example of FIG. 2, the predicted position of the vehicle A 300a in the prediction data A and the predicted position of the vehicle Y1 (=the vehicle A 300a) in the prediction data B are within the first distance σ₁.

Next, the correction data generation unit 102 performs the following processes 111 to 119 for each group.

First, the correction data generation unit 102 selects one unselected group from a plurality of groups (process 111).

Then, the correction data generation unit 102 determines whether or not the predicted position Po_i of the transmission source vehicle 300 is included in the predicted positions GPi included in the selected group (process 112).

When the predicted position Po_i of the transmission source vehicle 300 is included in the selected group, the correction data generation unit 102 calculates a mean position GPi_a and a positional standard deviation GPi_sd of the predicted positions GPi excluding the predicted position Po_i of the transmission source vehicle 300 (process 113). A group that includes the predicted position Po_i is equivalent to a correction target group. Further, the mean position GPi_a is equivalent to a first mean position.

It is assumed that the predicted positions Po_i of the plurality of transmission source vehicles 300 are not included in the predicted positions GPi. As described above, the length and width of the vehicle are reflected in the first distance σ₁, so that it is unlikely that the predicted positions Po_i of the plurality of transmission source vehicles 300 are included in the same group.

Next, the correction data generation unit 102 determines a second distance σ₂ (process 114). Specifically, the correction data generation unit 102 sets ±2*GPi_sd as the second distance σ₂, with using the positional standard deviation GPi_sd.

Next, the correction data generation unit 102 selects the predicted positions GPi located within the second distance σ₂ from the mean position GPi_a (process 115). That is, the correction data generation unit 102 selects the predicted positions located within GPi_a±2*GPi_sd.

Next, the correction data generation unit 102 calculates the mean position of the predicted positions GPi (including the predicted position GPi_o of the transmission source vehicle 300) selected in the process 115 (process 116). The mean position calculated in the process 116 is equivalent to a second mean position.

Then, the correction data generation unit 102 uses the mean position calculated in the process 116, as the estimated position of the transmission source vehicle 300 (process 117).

In the process 112, when the predicted position Po_i of the transmission source vehicle 300 is not included in the selected group, the correction data generation unit 102 calculates the mean position and the positional standard deviation of all of the predicted positions GPi, and estimates the position by performing the same processes described above (process 118).

Further, the correction data generation unit 102 stores the estimated position acquired in the process 117 and the estimated position acquired in the process 118 into the auxiliary storage device 903, together with the reference time (process 119).

After completing the process 119 for all groups, as illustrated in FIG. 9, the correction data generation unit 102 extracts for each transmission source vehicle 300, a positional difference of the transmission source vehicle 300 and positional differences of the surrounding objects (step S107).

Specifically, the correction data generation unit 102 extracts a difference between the predicted position of the transmission source vehicle 300 calculated in step S105 and the estimated position of the transmission source vehicle 300 calculated in step S106 (process 117). Further, the correction data generation unit 102 extracts a difference between the predicted position of each surrounding object calculated in step S105 and the estimated position of each surrounding object calculated in step S106 (process 118).

Next, the correction data generation unit 102 adjusts the positional difference acquired in step S107, with using a time difference (step S108).

The positional difference acquired in step S107 is a difference between the predicted position and the estimated position at the reference time. The measured position indicated in the vehicle data transmitted from the transmission source vehicle 300 is a position at the measurement time. For this reason, the correction data generation unit 102 adjusts the positional difference acquired in step S107 so as to reflect the difference between the measurement time and the reference time.

Specifically, the correction data generation unit 102 performs the following process.

Here, it is assumed that the position of the transmission source vehicle 300 at a measurement time ti indicated in the vehicle data is referred to as Psrc_i.

Further, the predicted position (the predicted position calculated in step S105) of the transmission source vehicle 300 at the reference time t is referred to as Ppre_i.

Further, the estimated position of the transmission source vehicle 300 calculated in step S106 is referred to as Presult_i.

Further, the positional difference of the transmission source vehicle 300 acquired in step S107 is referred to as (Presult_i−Ppre_i).

In step S108, the correction data generation unit 102 adjusts the positional difference with using the time difference by means of “(Presult_i−Ppre_i)*(1−(t−ti)/cycle)”. Note that “cycle” is a waiting time in step S103.

The correction data generation unit 102 performs the same process for each surrounding object.

Values acquired in step S108 are the correction values and equivalent to δ11 to δ14 and δ21 to δ23 indicated in FIG. 2.

Next, the correction data generation unit 102 generates the correction data for each transmission source vehicle 300 with using the values acquired in step S108 (step S109).

Then, the transmission unit 103 transmits for each transmission source vehicle 300, the correction data generated in step S10) (step S110).

After that, as illustrated in FIG. 8, each on-vehicle device 200 receives the correction data and corrects the position with using the correction data.

In the above, the example has been described in which the correction data generation unit 102 generates the correction data for correcting the measured position of the transmission source vehicle 300 and the measured positions of the surrounding objects. Instead of this, the correction data generation unit 102 may generate the correction data for correcting only the measured position of the transmission source vehicle 300. In this case, the on-vehicle device 200 corrects only the measured position of the vehicle 300 with using the correction data.

Further, in the above, the vehicle 300 has been described as an example of the moving body. However, the position correction system 500 according to the present embodiment is able to be applied to moving bodies other than the vehicle, such as a pedestrian and a robot.

### Description of Effect of Embodiment

As described above, according to the present embodiment, it is possible to correct a position in a short time.

As described above, in the technique of Patent Literature 1, the vehicle α is not able to correct the position unless the vehicle α repeats a plurality of times to receive a measured position from a surrounding vehicle and repeats a plurality of times to collate the measured positions from the surrounding vehicle with the measured position by the vehicle α. For this reason, in the technique of Patent Literature 1, it takes time to correct the position.

In the present embodiment, each on-vehicle device 200 is able to correct the position only by transmitting the vehicle data and receiving the correction data. That is, according to the present embodiment, each on-vehicle device 200 is able to correct the position without a plurality of times of communications and a plurality of times of collations.

Further, in the technique of Patent Literature 1, the vehicle α is not able to correct the position unless there is a surrounding vehicle that is able to measure the position of the vehicle α.

In the present embodiment, even when two vehicles are not able to mutually measure the position of the other, the two vehicles are able to correct each position if another vehicle is able to measure the positions of the two vehicles. For example, it is assumed that a vehicle P is in a state of not being able to measure a position of a vehicle Q and the vehicle Q is in a state of not being able to measure a position of the vehicle P. Further, it is assumed that a vehicle R is in a state of being able to measure the position of the vehicle P and the position of the vehicle Q. In this case, the vehicle P transmits the measured position of the vehicle P to the correction data generation device 100. Further, the vehicle Q transmits the measured position of the vehicle Q to the correction data generation device 100. Further, the vehicle R transmits to the correction data generation device 100, the measured position of the vehicle P and the measured position of the vehicle Q, as the measured positions of the surrounding objects. The correction data generation device 100 is able to transmit to the vehicle P, the correction data for correcting the measured position of the vehicle P, with using the measured position of the vehicle P from the vehicle P and the measured position of the surrounding object (the measured position of the vehicle P) from the vehicle R. Similarly, the correction data generation device 100 is able to transmit to the vehicle Q, the correction data for correcting the measured position of the vehicle Q, with using the measured position of the vehicle Q from the vehicle Q and the measured position of the surrounding object (the measured position of the vehicle Q) from the vehicle R.

Further, in the technique of Patent Literature 1, only the position of the vehicle α can be corrected. That is, in the technique of Patent Literature 1, a position of a surrounding object cannot be corrected.

According to the present embodiment, the position of the surrounding object can be also corrected.

### Supplementary Description of Hardware Configuration

Finally, a supplementary description of the hardware configuration of the on-vehicle device 200 and the hardware configuration of the correction data generation device 100 will be given.

The processor 801 illustrated in FIG. 5 is an Integrated Circuit (IC) that performs processing.

The processor 801 is a Central Processing Unit (CPU), a Digital Signal Processor (DSP), or the like.

The main storage device 802 illustrated in FIG. 5 is a Random Access Memory (RAM).

The auxiliary storage device 803 illustrated in FIG. 5 is a Read Only Memory (ROM), a flash memory, a Hard Disk Drive (HDD), or the like.

The communication device 804 illustrated in FIG. 5 is an electronic circuit that executes a communication process for data.

The communication device 804 is, for example, a communication chip or a Network Interface Card (NIC).

Further, the auxiliary storage device 803 also stores an Operating System (OS).

Then, at least a part of the OS is executed by the processor 801.

While executing at least the part of the OS, the processor 801 executes the programs that implement the functions of the vehicle position measurement unit 201, the surrounding object position measurement unit 202, the transmission unit 203, the reception unit 204, and the correction unit 205.

By the processor 801 executing the OS, task management, memory management, file management, communication control, and the like are performed.

Further, at least one of information, data, a signal vale, and a variable value that indicate results of processes of the vehicle position measurement unit 201, the surrounding object position measurement unit 202, the transmission unit 203, the reception unit 204, and the correction unit 205 is stored in at least one of the main storage device 802, the auxiliary storage device 803, and a register and a cache memory in the processor 801.

Further, the programs that implement the functions of the vehicle position measurement unit 201, the surrounding object position measurement unit 202, the transmission unit 203, the reception unit 204, and the correction unit 205 may be stored in a portable recording medium such as a magnetic disk, a flexible disk, an optical disc, a compact disc, a Blu-ray (registered trademark) disc, or a DVD. Then, the portable recording medium storing the programs that implement the functions of the vehicle position measurement unit 201, the surrounding object position measurement unit 202, the transmission unit 203, the reception unit 204, and the correction unit 205 may be distributed.

Further, the “unit” of each of the vehicle position measurement unit 201, the surrounding object position measurement unit 202, the transmission unit 203, the reception unit 204, and the correction unit 205 may be read as a “circuit”, “step”, “procedure”, “process” or “circuitry”.

Further, the on-vehicle device 200 may be implemented by a processing circuit. The processing circuit is, for example, a logic Integrated Circuit (IC), a Gate Array (GA), an Application Specific Integrated Circuit (ASIC), or a Field-Programmable Gate Array (FPGA).

In this case, each of the vehicle position measurement unit 201, the surrounding object position measurement unit 202, the transmission unit 203, the reception unit 204, and the correction unit 205 is implemented as a part of the processing circuit.

The processor 901 illustrated in FIG. 6 is an IC that performs processing.

The processor 901 is a CPU, a DSP, or the like.

The main storage device 902 illustrated in FIG. 6 is a RAM.

The auxiliary storage device 903 illustrated in FIG. 6 is a ROM, a flash memory, an HDD, or the like.

The communication device 904 illustrated in FIG. 6 is an electronic circuit that executes a communication process for data.

The communication device 904 is, for example, a communication chip or an NIC.

Further, the auxiliary storage device 903 also stores an Operating System (OS).

Then, at least a part of the OS is executed by the processor 901.

While executing at least the part of the OS, the processor 901 executes the programs that implement the functions of the reception unit 101, the data correction generation unit 102, and the transmission unit 103.

By the processor 901 executing the OS, task management, memory management, file management, communication control, and the like are performed.

Further, at least one of information, data, a signal vale, and a variable value that indicate results of processes of the reception unit 101, the data correction generation unit 102, and the transmission unit 103 is stored in at least one of the main storage device 902, the auxiliary storage device 903, and a register and a cache memory in the processor 901.

Further, the programs that implement the functions of the reception unit 101, the data correction generation unit 102, and the transmission unit 103 may be stored in a portable recording medium such as a magnetic disk, a flexible disk, an optical disc, a compact disc, a Blu-ray (registered trademark) disc, a DVD. Then, the portable recording medium storing the programs that implement the functions of the reception unit 101, the data correction generation unit 102, and the transmission unit 103 may be distributed.

Further, the “unit” of each of the reception unit 101, the data correction generation unit 102, and the transmission unit 103 may be read as a “circuit”, “step”, “procedure”, “process” or “circuitry”.

Further, the correction data generation device 100 may be implemented by a processing circuit. The processing circuit is, for example, a logic IC, a GA, an ASIC, or an FPGA.

In this case, each of the reception unit 101, the correction data generation unit 102, and the transmission unit 103 is implemented as a part of the processing circuit.

Note that, in the present specification, a superordinate concept of the processor and the processing circuit is referred to as “processing circuitry”.

That is, each of the processor and the processing circuit is a specific example of the “processing circuitry”.

### REFERENCE SIGNS LIST

100: correction data generation device; 101: reception unit; 102: correction data generation unit; 103: transmission unit; 200: on-vehicle device; 200a: on-vehicle device A; 200b: on-vehicle device B; 201: vehicle position measurement unit; 202: surrounding object position measurement unit; 203: transmission unit; 204: reception unit; 205: correction unit; 300: vehicle; 300a: vehicle A; 300b: vehicle B; 300c: vehicle C; 300d: vehicle D; 300n: vehicle N; 400: pedestrian; 500: position correction system; 801: processor; 802: main storage device; 803: auxiliary storage device; 804: communication device; 901: processor; 902: main storage device; 903: auxiliary storage device; 904: communication device

1. A correction data generation device comprising:
processing circuitry:
to receive from each moving body among a plurality of moving bodies, moving body data indicating a measured position of each moving body which is a position of each moving body measured at each moving body at an individual timing and may include an error, indicating a measured position of a surrounding object of each moving body which is a position of the surrounding object of each moving body measured at each moving body at an individual timing and may include an error, and indicating a measurement time which is a time at which the measured position of each moving body and the measured position of the surrounding object of each moving body have been measured;
to calculate a predicted position of each moving body and a predicted position of the surrounding object of each moving body at a reference time, the reference time being a time after measurement times of the plurality of moving bodies and a time commonly applied to the plurality of moving bodies, with using the measured position of each moving body, the measured position of the surrounding object of each moving body, and the measurement time of each moving body indicated in a plurality of moving body data received from the plurality of moving bodies, to integrate the predicted positions of the plurality of moving bodies at the reference time and the predicted positions of the surrounding objects of the plurality of moving bodies at the reference time, to analyze a distribution of the predicted positions acquired by integration, to calculate a position at the reference time at which each moving body is estimated to be located, as an estimated position of each moving body at the reference time, and to generate for each moving body, correction data for correcting the error that may be included in the measured position of each moving body, with using the estimated position of each moving body at the reference time; and
to transmit to each moving body, the correction data for each moving body generated, wherein
the processing circuitry groups predicted positions mutually located within a first distance in the distribution of the predicted positions acquired by the integration,
extracts from a plurality of groups acquired by grouping, a correction target group which is a group including a predicted position of any moving body, calculates as a first mean position, a mean position of predicted positions included in the correction target group excluding the predicted position of the moving body whose predicted position is included in the corrected target group,
calculates as a second mean position, a mean position of predicted positions located within a second distance from the first mean position among the predicted positions included in the correction target group, and
uses the second mean position as an estimated position of the moving body whose predicted position is included in the correction target group.

2. The correction data generation device according to claim 1, wherein
the processing circuitry generates for each moving body, correction data for correcting the error that may be included in the measured position of each moving body and the error that may be included in the measured position of the surrounding object of each moving body.

3. The correction data generation device according to claim 1, wherein
the processing circuitry generates with using a difference between the estimated position of the moving body whose predicted position is included in the correction target group and the predicted position of the moving body, and a difference between the reference time and a measurement time indicated in moving body data from the moving body, the correction data of the moving body.

4. The correction data generation device according to claim 1, wherein
the processing circuitry calculates a standard deviation of the predicted positions included in the correction target group excluding the predicted position of the moving body whose predicted position is included in the correction target group and
determines the second distance with using the standard deviation.

5. The correction data generation device according to claim 1, wherein
the processing circuitry receives from each moving body of the plurality of moving bodies, moving body data indicating a measured speed of each moving body which is a speed of each moving body measured at each moving body, and
the processing circuitry calculates the predicted position of each moving body and the predicted position of the surrounding object of each moving body, with using the measured position of each moving body, the measured speed of each moving body, the measured position of the surrounding object of each moving body, and the measurement time of each moving body, indicated in each moving body data.

6. The correction data generation device according to claim 1, wherein
the processing circuitry calculates the predicted position of each moving body and the predicted position of the surrounding object of each moving body, with using a latest measurement time among the measurement times of the plurality of moving bodies, as the reference time.

7. The correction data generation device according to claim 1, wherein
the plurality of moving bodies is a plurality of vehicles that travels a roadway and
the correction data generation device is a roadside server device located on a side of the roadway.

8. A correction data generation method comprising:
receiving from each moving body among a plurality of moving bodies, moving body data indicating a measured position of each moving body which is a position of each moving body measured at each moving body at an individual timing and may include an error, indicating a measured position of a surrounding object of each moving body which is a position of the surrounding object of each moving body measured at each moving body at an individual timing and may include an error, and indicating a measurement time which is a time at which the measured position of each moving body and the measured position of the surrounding object of each moving body have been measured;
calculating a predicted position of each moving body and a predicted position of the surrounding object of each moving body at a reference time, the reference time being a time after measurement times of the plurality of moving bodies and a time commonly applied to the plurality of moving bodies, with using the measured position of each moving body, the measured position of the surrounding object of each moving body, and the measurement time of each moving body indicated in a plurality of moving body data received from the plurality of moving bodies, integrating the predicted positions of the plurality of moving bodies at the reference time and the predicted positions of the surrounding objects of the plurality of moving bodies at the reference time, analyzing a distribution of the predicted positions acquired by integration, calculating a position at the reference time at which each moving body is estimated to be located, as an estimated position of each moving body at the reference time, and generating for each moving body, correction data for correcting the error that may be included in the measured position of each moving body, with using the estimated position of each moving body at the reference time;
transmitting to each moving body, the correction data for each moving body generated; and
in calculating the estimated position,
grouping predicted positions mutually located within a first distance in the distribution of the predicted positions acquired by the integration,
extracting from a plurality of groups acquired by grouping, a correction target group which is a group including a predicted position of any moving body, calculating as a first mean position, a mean position of predicted positions included in the correction target group excluding the predicted position of the moving body whose predicted position is included in the corrected target group,
calculating as a second mean position, a mean position of predicted positions located within a second distance from the first mean position among the predicted positions included in the correction target group, and
using the second mean position as an estimated position of the moving body whose predicted position is included in the correction target group.

9. A non-transitory computer readable medium storing a correction data generation program for causing a computer to execute:
a reception process to receive from each moving body among a plurality of moving bodies, moving body data indicating a measured position of each moving body which is a position of each moving body measured at each moving body at an individual timing and may include an error, indicating a measured position of a surrounding object of each moving body which is a position of the surrounding object of each moving body measured at each moving body at an individual timing and may include an error, and indicating a measurement time which is a time at which the measured position of each moving body and the measured position of the surrounding object of each moving body have been measured;
a correction data generation process to calculate a predicted position of each moving body and a predicted position of the surrounding object of each moving body at a reference time, the reference time being a time after measurement times of the plurality of moving bodies and a time commonly applied to the plurality of moving bodies, with using the measured position of each moving body, the measured position of the surrounding object of each moving body, and the measurement time of each moving body indicated in a plurality of moving body data received from the plurality of moving bodies, to integrate the predicted positions of the plurality of moving bodies at the reference time and the predicted positions of the surrounding objects of the plurality of moving bodies at the reference time, to analyze a distribution of the predicted positions acquired by integration, to calculate a position at the reference time at which each moving body is estimated to be located, as an estimated position of each moving body at the reference time, and to generate for each moving body, correction data for correcting the error that may be included in the measured position of each moving body, with using the estimated position of each moving body at the reference time; and
a transmission process to transmit to each moving body, the correction data for each moving body generated by the correction data generation process, wherein
in the correction data generation process, the correction data generation program causes the computer to:
group predicted positions mutually located within a first distance in the distribution of the predicted positions acquired by the integration,
extract from a plurality of groups acquired by grouping, a correction target group which is a group including a predicted position of any moving body, calculates as a first mean position, a mean position of predicted positions included in the correction target group excluding the predicted position of the moving body whose predicted position is included in the corrected target group,
calculate as a second mean position, a mean position of predicted positions located within a second distance from the first mean position among the predicted positions included in the correction target group, and
use the second mean position as an estimated position of the moving body whose predicted position is included in the correction target group.
